(19) United States
(12) Patent Application Publication
(10) Pub. No.: US 2006/0036465 A1
(43) Pub. Date: Feb. 16, 2006

(54) Online interactive interface and automated processing for loan origination and underwriting

(76) Inventor: Lee Francis O'Donnell, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/203,031

(22) Filed: Aug. 12, 2005

Related U.S. Application Data
(60) Provisional application No. 60/601,595, filed on Aug. 13, 2004.

(51) Int. Cl. G06Q 99/00

(52) U.S. Cl. 705/1

(57) ABSTRACT

A user is provided an online interactive interface to fill in a loan origination form, to finance the purchase of a business. The form requests information about the business, including expense items associated with operating the business. Information that is reflected in the filled form is then transmitted to a lender and informs the lender's decision to approve a loan for financing the property. The transmitted information reflects the expense items in the same format as a form used by a professional appraiser to report to the lender an appraisal of the business. Other embodiments are also described and claimed.

This application claims the benefit of the earlier U.S. filing date of Provisional Application No. 60/601,595, filed Aug. 13, 2004.

An embodiment of the invention is related to an online interactive interface that presents a form to the user for originating a loan to finance a business, such as the purchase or refinance of income generating real property. Other embodiments are also described.

### BACKGROUND

The purchase or refinance of income generating real estate, such as a multi-family dwelling with its rental units being operated as a business, has a well developed history in this country. An investor or borrower may approach a mortgage professional, such as a mortgage broker, with a particular piece of property in mind to be purchased. Alternatively, the investor may seek to refinance the existing loan on a property he owns. The broker may have a relationship with several lenders, including banks and/or real estate investment trusts, and will determine which of them will likely be interested in the transaction.

Each lender typically has its own, customized form which is often referred to as a transaction summary/loan quote form that is to be filled out by the broker to gauge the interest of the lender in the transaction. With email and Internet use becoming more pervasive, such forms are now available as document files that can be downloaded by the broker. The form is typically printed by the broker, and filled in by hand writing before being faxed back to the lender. The requested information includes the name of the property, the property address, the type of loan program desired, the purchase price or, in the case of refinance, the value of the property, the apartment unit mix (i.e., how many one bedroom units, how many two bedroom units, etc.), and the type of loan program sought. The lender also requires that the broker specify the total current base rents that are collected for the property, as well as certain, broad categories of operating expenses such as taxes, insurance, utilities, repairs and maintenance, and management salaries. Each lender typically has a different spread for the expenses associated with operating the property.

Lenders typically require that the income categories, as well as the operating expense categories be completely filled in, or else the lender will probably not issue a loan quote until the additional information is filled in. The experienced broker, knowing this, will thus have to spend a considerable period of time interviewing the investor and investigating the property to obtain the required income and expense information, as well as carefully fill out the form (else it will be rejected by the lender).

Once the form has been properly filled and sent back to the lender, a loan officer at the lender will manually enter the information into an electronic file, such as a spreadsheet file. The loan officer then reviews the information including any calculations that may be performed by the spreadsheet to provide some figures of merit regarding the different loan programs that have been requested. If the property meets certain criteria, for example cash flow, the loan officer may issue a preliminary loan quote letter. This letter does not constitute a commitment or offer to lend on the part of the lender, but rather to present for review purposes, the available loan programs that may be of interest. The final determination to lend, as well as the loan amount and the terms are not established until a completed loan application is initiated and all pertinent documents including appraisal reports are received, reviewed and verified.

The loan quote letter sometimes referred to as the “letter of interest”, will also specify the additional information needed by the lender before a commitment can be given to fund the loan. The pertinent documents may include a detailed, current rent roll, an operating statement and expense forecast, including historical data for the past and previous years, and color photographs of the property. In addition, the lender may request the broker to obtain borrower information, including a schedule of real estate owned by the borrower, a copy of a credit report, and previous years income tax returns. The broker will then collect this information and typically send the copies by facsimile to the loan officer. The loan officer and/or his assistant must then sift through this paperwork to make sure that the needed information is there. The information is then entered into a spreadsheet file that calculates further loan figures of merit, based on the completed detailed information. A senior loan officer or underwriter may then review the collected data and the calculations made by the new spreadsheet, and authorize the issuance of a conditional approval letter. If the investor agrees with the terms in the conditional letter, a deposit is then paid to the lender to proceed with the loan approval process (e.g., appraisal, environmental, and other third party reports).

In response to the deposit being made, the lender may then order an appraisal of the property to verify the income and expenses information and to compare them to comparable properties in the same area. In the U.S., the appraisal report typically arrives as a Form 71A Appraisal Report for Residential Income Property and Small Balance Commercial Property. A loan professional then enters the income and expense information from the report into a spreadsheet file that calculates loan figures of merit. The spreadsheet will also include the abbreviated expenses received from the broker, and thus will need to show a meaningful comparison between those abbreviated categories and the more detailed items of the appraisal. The underwriter will adjust the expense items in accordance with the appraisal report. This updated spreadsheet may then be submitted as part of an executive summary to a loan committee, for a final decision on approving the loan.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 shows the different users involved in an embodiment of the invention.

FIGS. 2-3 show an overview of the end-to-end loan origination and underwriting process, according to an embodiment of the invention.

FIG. 4 shows an example Loan Program section of an online interactive form.

FIG. 5 shows example Property and Buyer Information sections of the form.

FIG. 6 illustrates the items relevant to a refinance transaction, in an example Transaction Summary section of the form.

FIG. 7 is an example Property Information section of the form.

FIG. 8 is an example Property Expense section of the form.

FIG. 9 shows an example Rent Roll section of the form.

FIG. 10 shows an example Operating History section of the form.

FIG. 11 shows an example Attach Photograph section of the form.

FIG. 12 is an example Spreadsheet section of the form.

FIG. 13 is an example Web page that shows an overview of the list of properties that have been entered into the software by a broker, as well as a list of the different tools that may be available for online use by the broker.

FIG. 14 is an example Loan and Investment Sizer section of the form.

FIG. 15 is an example Expense Library section of the form.

FIG. 16 shows an example spreadsheet part of a loan submission package, in accordance with an embodiment of the invention.

FIG. 17 shows a historical operating statement that may be automatically generated by an embodiment of the invention, for a self-storage facility.

FIG. 18 shows a transaction summary page that can be automatically generated by an embodiment of the invention, for a hospitality transaction.

### DETAILED DESCRIPTION

The above described process of loan origination and underwriting, although widely accepted and used in the U.S. for many years, suffers from a number of inefficiencies. For example, each lender typically uses its own custom-defined (or internal) format for operating expenses, to calculate the figures of merit for final underwriting, as appears in the executive summary that is presented to the loan committee. The underwriter thus needs to spend considerable time translating between the information received from the broker and the internal format. In addition, the income and expense values from the appraisal report need to be “aligned” with those in the internal format, to yield meaningful comparisons. This contributes to inefficiencies at the lender in processing the broker submission.

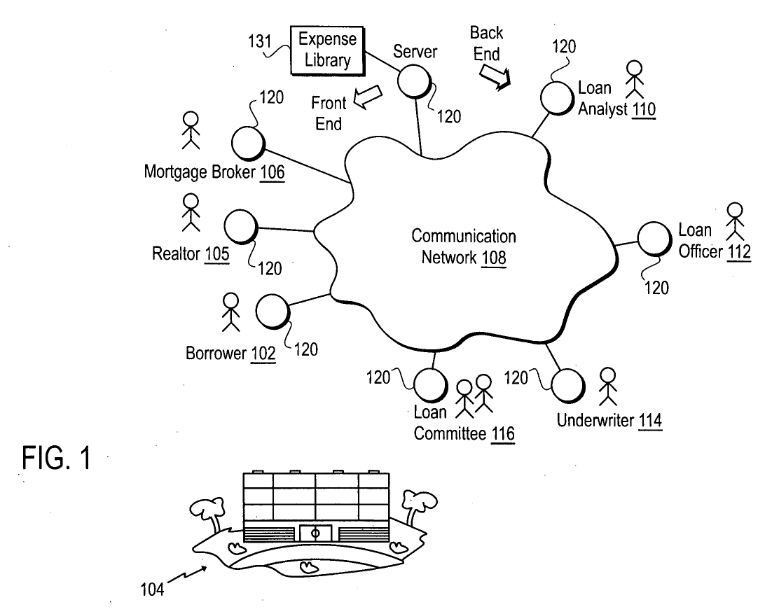

According to an embodiment of the invention, an online interactive interface for, and the automated processing of, loan origination and underwriting is disclosed. FIG. 1 shows the different users involved in an embodiment of the invention. The process typically begins with a borrower 102 having in mind a property 104 to either purchase or refinance. The property here is referred to as “income generating” in the sense that it will be used primarily as a business to generate income. The description here focuses on just one example, namely a multi-family dwelling, such as an apartment building, a mixed use building, or a mobile home park. However, the concepts may be applicable to other types of businesses, including commercial real estate such as a laundromat, an office building, a strip shopping center, an industrial park, a medical building, self-storage and hospitality properties, including hotels, motels, bed and breakfasts, and youth hostels. A “multi-family” residential building is preferably one that has five units or more for which the lending criteria requires a list of itemized operating expenses associated with operating the property. With income generating real estate, the property itself is relied upon by the lender for financial recovery, in the event the borrower defaults on the loan. Accordingly, a detailed analysis of the operating income and expenses is typically performed prior to agreeing to fund the loan.

The borrower 102 typically seeks the services of a mortgage broker 106 to secure the needed financing. The broker 106 may be a fulltime commercial broker, or he may be a single family, residential broker. A broker is able to learn, relatively quickly, how to use computer software that provides an online interactive form, according to the different embodiments of the invention described here, for the origination and processing of commercial loans. As an alternative, the user operating the software may be a realtor 105 (a real estate agent or real estate broker), a savvy investor (for example, the borrower 102 himself), or he may be an employee of a lender. To simplify and streamline the description of the different embodiments, the focus here will be mostly on the independent mortgage broker, however, the different embodiments of the invention are not limited to such a user.

The broker 106 has a business relationship with a number of lenders. There is also a loan analyst 110 who may be working for the same or different entity as the broker. For example, the broker may be working for a mortgage brokerage firm, whereas the loan analyst may be a member of a software services company such as Keep Input Simple Commercial Loans, Inc., of Nevada, U.S.A., that administers the software, or that of a commercial lending entity. There is also a loan officer 112, who may be an employee of a different lender. A senior loan officer or underwriter 114 is responsible for preparing an executive summary of the loan transaction to be reviewed and finally approved by a loan committee 116 of the lender.

Each of these human users may be able to communicate with the others using an electronic communication network 108, such as the Internet, with protocols that are email and Web-based. Electronic documents are said to be thus downloaded from the network 108 into the respective machine of the human user, where such machines may also be referred to as client machines 120 that are running client software. Well known examples include desktop computers, notebook computers, handheld email devices, or other computing devices that can store and display the various documents involved in the processing of the loan transaction.

The different embodiments of the invention may be implemented by a server 130 that has access to a stored, expense library 131, where “server” in this case refers to either a single server machine or a network of multiple server machines. Software running in the server will support a front end, online interactive interface to a user, such as the broker, and a back end interface to the loan analyst and lenders. The figures to be described below are various screen shots of a Web-based, online interactive interface at the front end of the software. The back end may also have a similar graphical user interface, but customized for each individual lender. As an alternative, the back end may simply be an automatic process that emails either document format (e.g., pdf) or spreadsheet files (e.g., MICROSOFT EXCEL) containing the information input by the broker into the form, to an email address of a loan officer of the lender. These files may include operating expense items relating to the property, as reported by the broker and/or automatically filled by the software. In addition, they may include a separate listing of filled expense categories in the internal format of the lender. Information in the document or spreadsheet file may then be imported into the lender's preexisting, loan underwriting software for detailed analysis and calculations relating to approval of the loan.

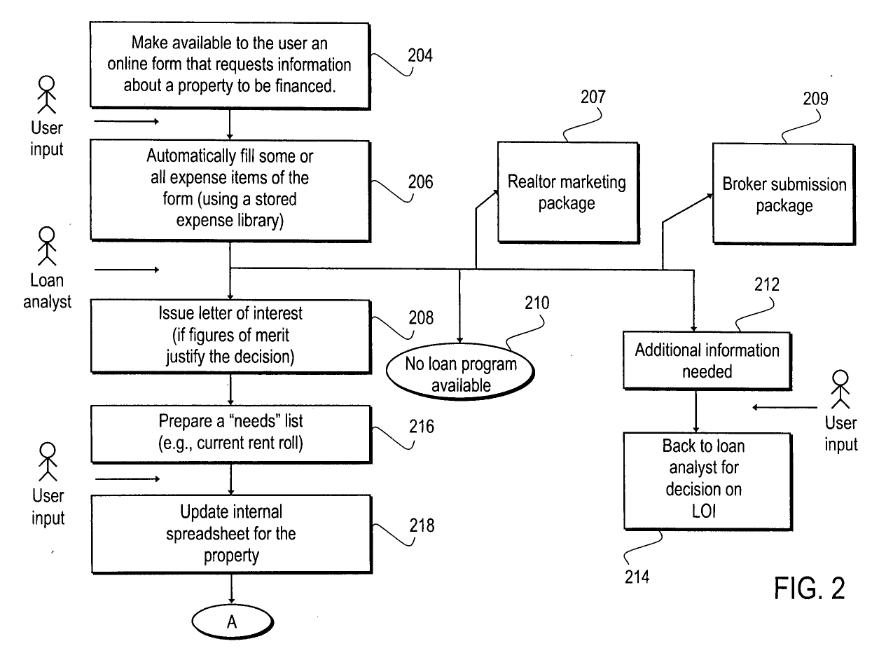

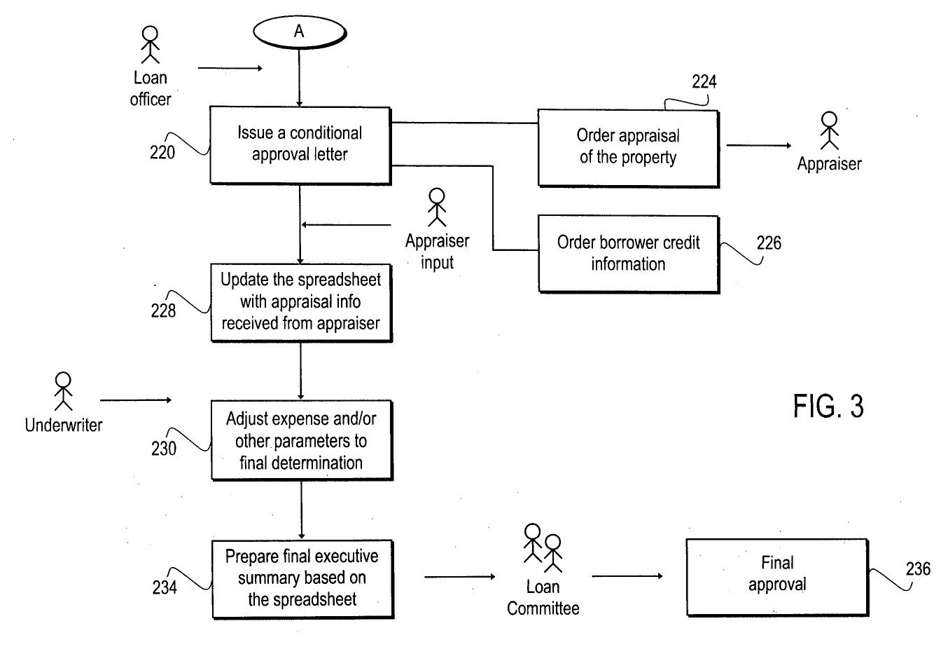

In FIGS. 2 and 3, an overview of a loan origination and underwriting process is shown, according to an embodiment of the invention. The process begins with operation 104 in which the software, at its front end, makes available to a user an online interactive form that requests information about the property. The user then enters the requested information, which is received by the software as filled out by the user. In an embodiment of the invention, the online form has an expense section that lists a number of different expense items associated with owning the property. As explained below, this list of expense items contains some (e.g., at least five) or all of those that are listed in a form used by professional appraisers to report their appraisal of a property to a lender (e.g., Form 71A).

Continuing with operation 206, the software automatically fills some or all of the expense items that have not been filled by the user. This is preferably done using the stored expense library 131 (see FIG. 1). The information received from the user is compared to that of comparable properties stored in the library, and an estimate of the expenses for the target property, based on the known or appraised expenses of comparable properties in the library, is calculated. Once completed, the form is submitted by the user clicking on a designated icon. The software may then automatically generate an email that contains a link to the online interactive form, where the email is sent to a loan analyst that may be working for the same entity that administers the software.

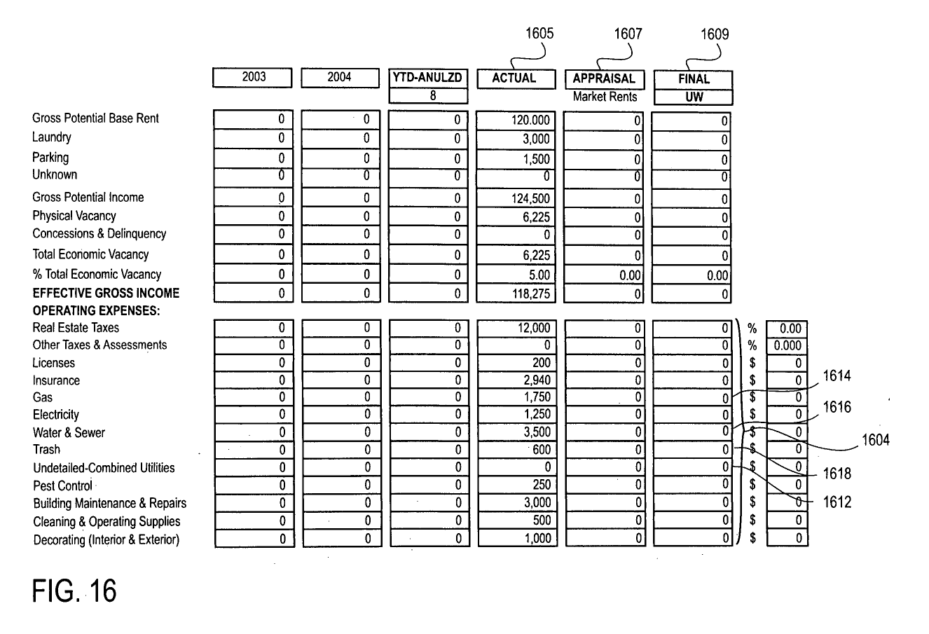

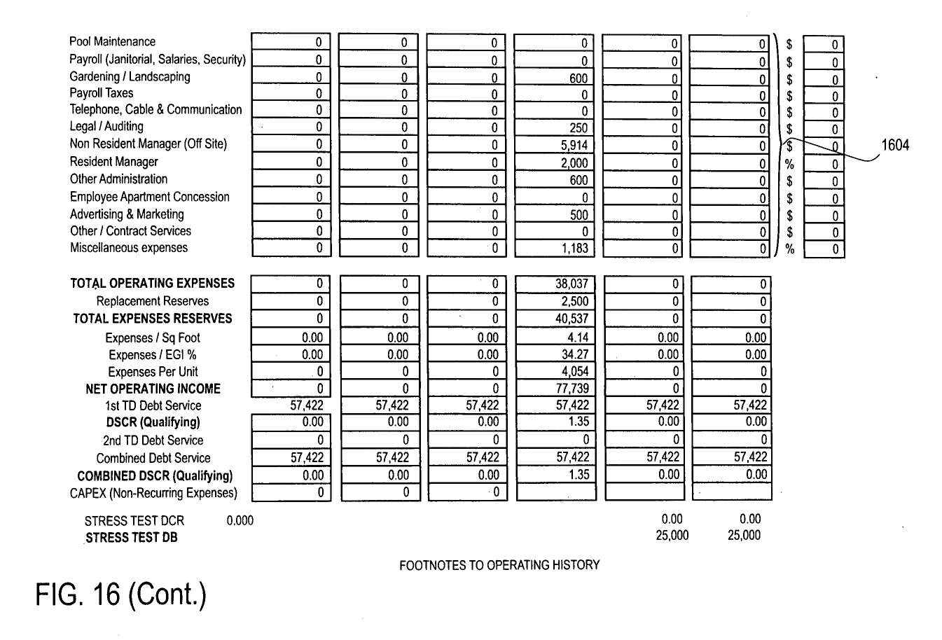

At this point, the software may also provide the user with a realtor marketing package 207 at the click of an icon, and a broker submission package 209 (see FIG. 16). The user may be a realtor that has himself discovered the property and may wish to distribute the realtor marketing package 207 to potential buyers, to gauge their interest in purchasing the target property. The user as a broker may send the broker submission package 209 directly to one or more lenders, independently of those selected by the loan analyst, to obtain a loan quote for the transaction. Both of these packages may be preferably in the form of a document file format such as pdf.

Note that in the preferred approach, the information that has been entered by the user in the form remains proprietary to the user, that is unknown to the loan analyst, until the user has elected to submit the form. This creates the confidence in the user that the administrator of the software, including the loan analyst that will be asked to forward the broker submission package to different lenders, will not pirate the broker's information. In some cases, the administrator may wish to allow the user access to the realtor marketing package and/or the broker submission package, even before the user has elected to submit the form.

Next, typically within twenty-four hours, a lender has been contacted with the information about the property (e.g., using either a broker submission package or another capability described as part of the back end of the software). A letter of interest, also referred to as a loan quote letter may then be issued (operation 208), by the lender, if the figures of merit calculated by the lender justify the decision. In practice, a loan officer at the lender may receive the broker submission package and enter the information into an internal spreadsheet that calculates the relevant figures of merit for that lender. As explained below, this information may advantageously include both a list of operating expense line items in the format reported by an appraiser of the property, as well as a separate list of expense categories that are in the internal format of the lender (both filled in, based on input from the broker and/or automatically by the software). One or more loan programs that are applicable may then be selected and reported back to the broker in the loan quote letter. Alternatively, there may be no loan program available, because, for example, the property simply does not support a sufficient return on investment (operation 210). In some cases, the lender may be interested in financing the property, however, will need additional information (operation 212) from the user before being able to quote a loan program.

The letter of interest or loan quote letter issued by a lender typically identifies the borrower, the target property, the amount of the loan, the interest rate, as well as the terms of the loan including, for example, prepayment penalties, index, and margins.

Returning to operation 216, in addition to the letter of interest, the lender may prepare a “needs list” before it can issue a conditional approval for the loan. Examples include a current rent roll, operating history for the property, and color photographs of the property. The user may input the requested information again directly into the interactive online form, and the software automatically updates an internal spreadsheet for the property (operation 218) that may then be forwarded to the lender.

Moving now to FIG. 3, once the requested information has been entered into the online interactive form and then relayed to the lender (via, for example, the loan analyst signaling the software that an email be sent to the lender with an attached document file, e.g. pdf, of the new information), a loan officer at the lender may update an internal spreadsheet of the lender with the new information and based on calculated figures of merit may decide that a conditional approval is warranted (operation 220). Once again, the operating expense items, in the operating history, as received from the loan analyst has already been automatically placed in the internal format of the lender. Then, if a deposit is timely received from the borrower, the lender will proceed with ordering an appraisal of the property from a professional appraiser (operation 224). In addition, borrower credit information may be ordered at this time (operation 226).

Sometime later, the appraisal information will arrive, typically as a Form 71A in the U.S., but other forms that are accepted by professional appraisal organizations may be used. According to an embodiment of the invention, the expense items listed in the information that was transmitted by the software's back end to the lender is in essentially the same format as that which is received from the appraiser. For example, both the nomenclature and the sequence of the operating expense items are essentially the same as that received from the appraiser. There may be a few items that are either slightly out of order, or that are missing, but the list is preferably at least 90% the same as that of the appraisal report. This synchronization considerably reduces the amount of time that the lender will spend processing and updating his spreadsheet with the appraisal information from the appraiser, and the operating history from the broker (operation 228).

As an alternative, the expense items transmitted to the lender may be in the internal format of the lender (which is typically a reduced or abbreviated version of what is reported in the appraisal). The translation between the format used in the front end form (by the broker), to the internal formats of multiple, different lenders may be implemented either automatically by the software, and/or via manual input from the loan analyst. In the preferred approach, the expense items transmitted to the lender (by the software) will appear in both formats (see, e.g. FIG. 16).

The lender spreadsheet may be delivered to a senior loan officer who adjusts the expenses and/or other parameters to a final determination of the loan figures of merit (operation 230). The senior officer may be with the same firm as the loan officer that prepared the conditional approval letter, or he may be a member of a different company. In either case, a final executive summary based on the completed and adjusted spreadsheet is prepared by the underwriter (operation 234) and submitted to a loan committee for final approval of the loan (operation 236).

Front End

Returning to the front end of the software, the preferred approach is to use a Web-based interface, beginning with a welcome page that gives a brief summary of the step-by-step loan submission process. The Web page will indicate to the user that if the form is properly completed, the user will have a much better chance of having the loan request placed in a more favorable position for review. As an alternative to the online interactive form, the forms may be downloaded in a document or spreadsheet format, and filled in offline before being sent to the lender.

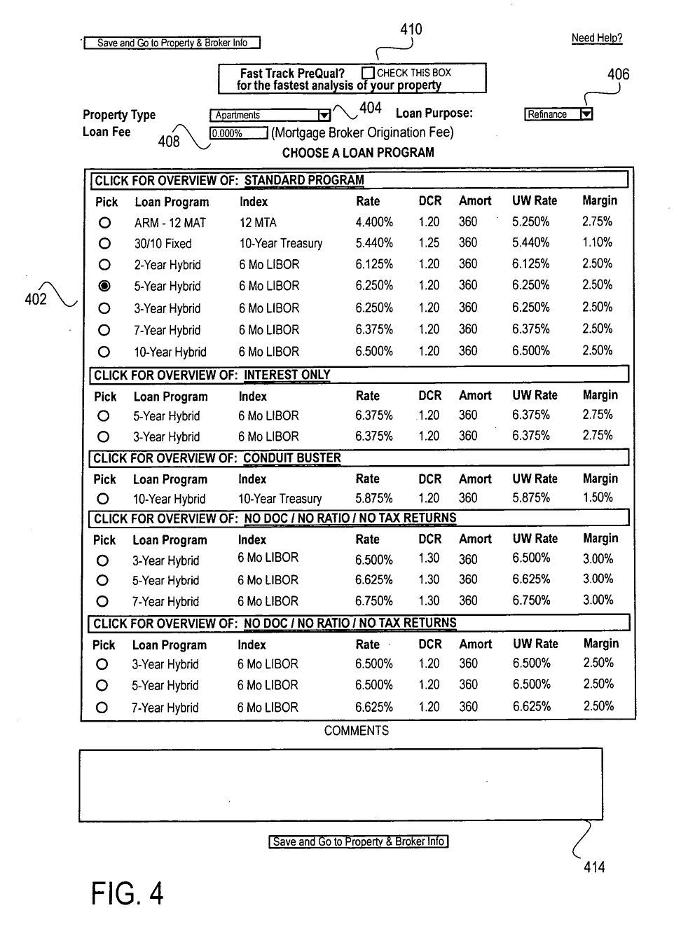

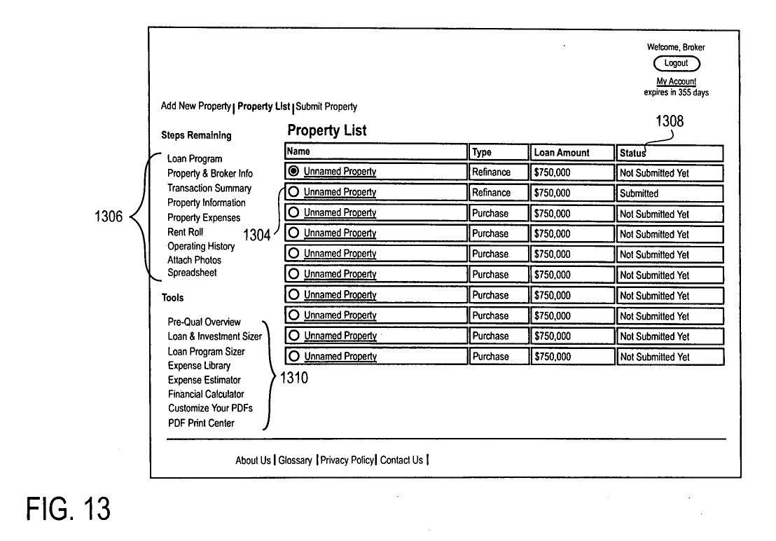

The operations described below, with respect to FIGS. 4-18 may be automated, by, for example, software running on a server that serves up Web pages that feature the illustrated form and allow for user interaction in entering selections and provides feedback to the user in real-time as, for example, calculations based on the user's selections. The Web pages reflect different sections of the loan origination form. As an alternative to the sequential approach described below, the software also allows each section to be entered out of order, by the user selecting the appropriate icon that may be listed in a separate frame 1306 (e.g., see FIG. 13). Note that at the end of each section, the user may request that the system save the entered information, update the calculations, and/or return to an earlier section of the form.

Operation begins with the user being prompted to enter his name and to select “Add New Property” to begin entering information for a new property. The software may have saved previously entered properties by this user, and can display them on this page, allowing the user to return to the file of a property that has either been “submitted” or that is still in the process (items 1304, see FIG. 13). The software keeps a copy of the updated form each time it is “submitted” by the user, so that a record of the changes is available should a lender request it (e.g., to explain why a loan has not been approved despite the issuance of a pre-qualification loan quote.) The next operation prompts the user to fill in the Loan Program section of the form.

Referring to FIG. 4, an example Loan Program page is shown where the user can select the particular type of loan programs he is interested in. One or more of the items 402 may be selected. Alternatively, none of them need to be selected by the user. In that case, the loan analyst reviewing the submission will determine which loan programs are appropriate for this transaction, and may forward that information to the lender.

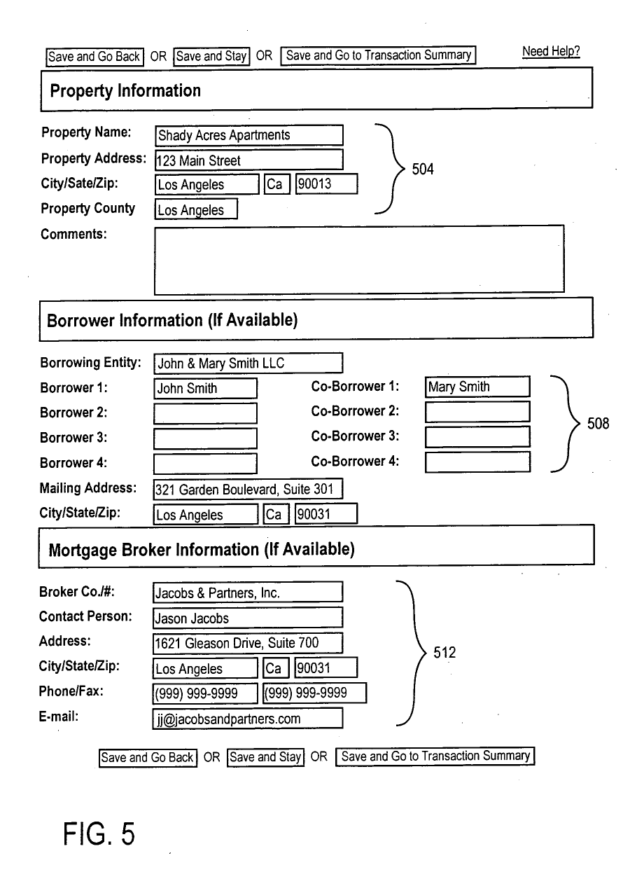

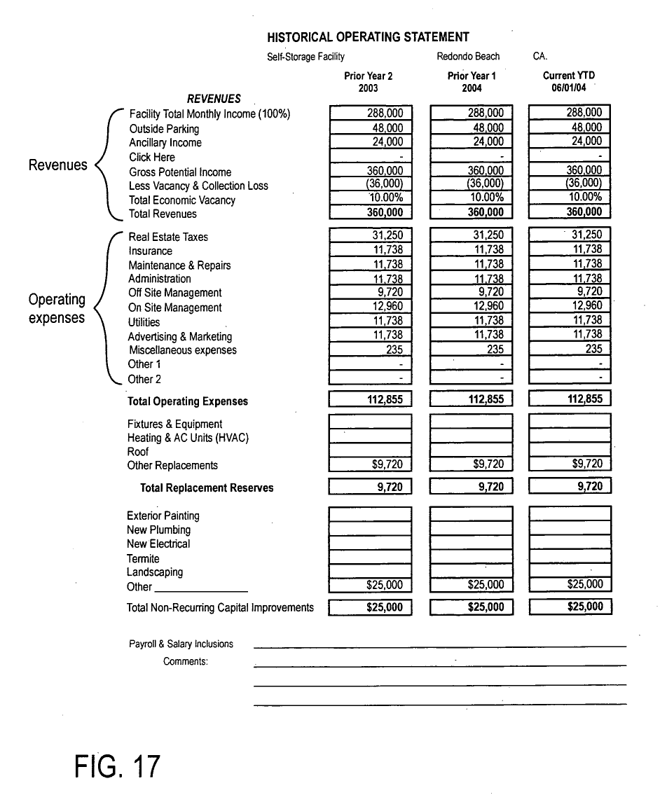

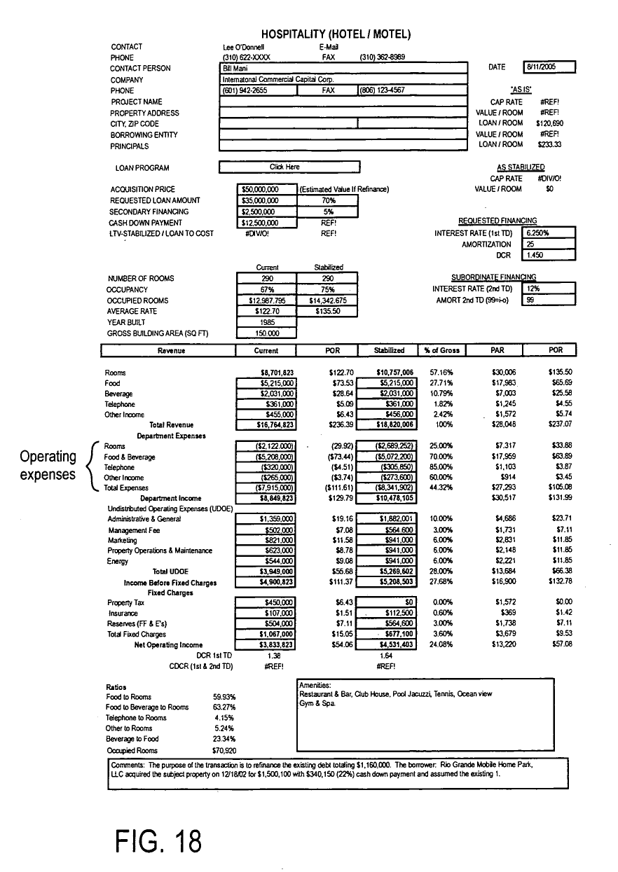

If the software is designed to support different types of income generating real properties (e.g., see the automatically generated Operating History and Transaction Summary sections of forms for a self-storage facility and hospitality transactions, in FIGS. 17 and 18), then the property type is preferably indicated on this page, for example, by a pull down menu 404. As mentioned above, for multi-family dwellings, the property types may be apartments, condominiums, and mobile home parks, for example. In addition, the user preferably indicates the purpose of the loan here (pull down menu 406), as either a purchase or a refinance. Finally, in the event the user is a broker, then the software requests, but does not require, that the broker indicate his desired origination fee that would be collected should the loan be funded, in terms of a percentage of the loan (item 408). Also, there is a comments section 414 in which the user can type in his comments that are designed to facilitate the approval of the loan. Operation then proceeds with the Property and Broker Information page (FIG. 5).

Before continuing with the description of FIG. 5, Note that FIG. 4 also shows an option box 410 to select a more abbreviated and accelerated submission process, for a faster analysis of the transaction. For example, with a regular 9-operation submission process that includes a Rent Roll section, Operating History section, and Attach Photographs section (see below), the accelerated process may have only five operations, and excludes the Rent Roll, Operating History, and Attach Photograph sections. Of course, a more complete submission process is likely to result in a more accurate loan quote, however, the accelerated process may result in a loan quote letter within twenty-four hours in many instances, a desirable feature for many investors who wish to make quick decisions on their investment. The accelerated process follows much of the same operations described below for the regular process, except where indicated.

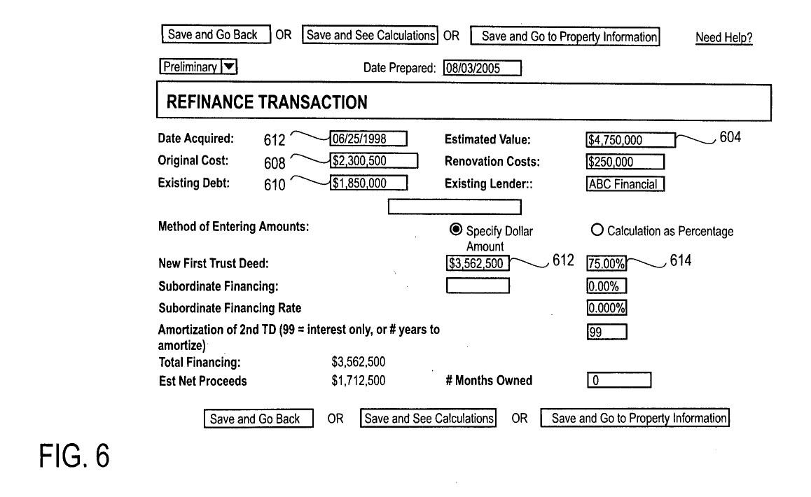

Turning now to FIG. 5, information that identifies the property is requested to be filled in at items 504, including the location of the property. Again, comments may be entered regarding the property, such as any desirable neighborhood features. Although optional, the user may also enter borrower information including the name and address of the borrower (item 508). Also, information about the broker may also be entered as well, in items 512. Operation then proceeds with the Transaction Summary section (FIG. 6).

FIG. 6 illustrates the items relevant to a refinance transaction. Note that in contrast, a purchase transaction would call for dialog boxes to enter the purchase price and the amount of the loan or cash down payment (either as a dollar amount or as a percentage of the purchase price). The refinance items include the value of the property (604), the original cost (608), the existing debt (610), and either the acquisition date (612) or alternatively the period of time owned. Items such as renovation costs and existing lender identity are optional. In addition, the desired new first trust deed that is expected by the borrower should be entered, either as a dollar amount (612) or as a percentage (614) of the value 604. Additional information, such as subordinate financing may be entered, if desired, in both the refinance and the purchase scenarios.

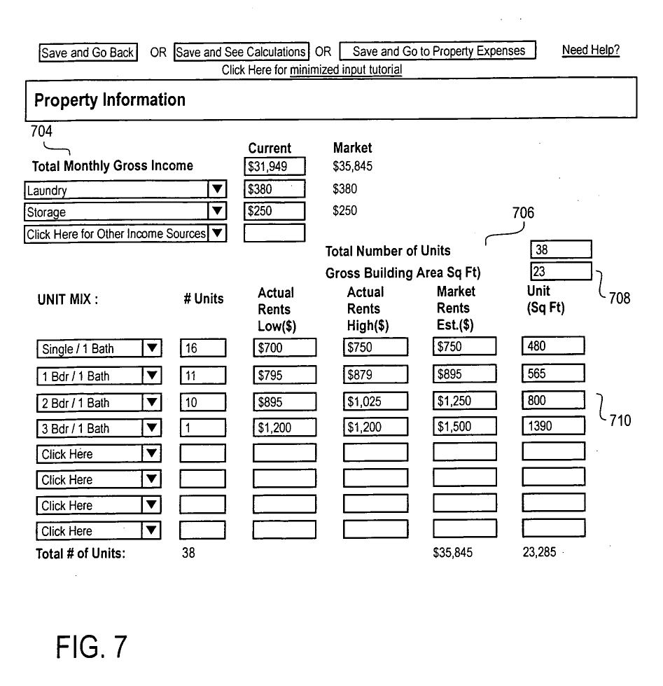

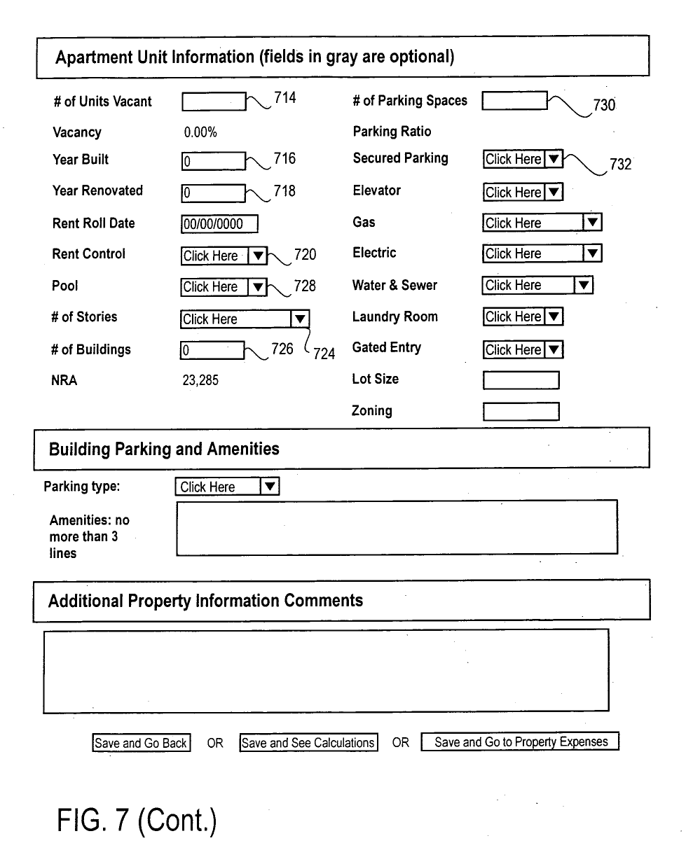

Note that FIG. 6 actually shows the Transaction Summary section of an accelerated process. In the regular submission process, the Transaction Summary may also provide for borrower financial-credit items, the filling of which is also optional. This may include the name of the borrowing entity, its liquid assets, total liabilities, and the number of years experience in operating commercial properties. Operation next proceeds with the Property Information section (FIG. 7).

In FIG. 7, which is an example of a regular (non-accelerated) process, the user is requested to enter not just income but also expense information about the property. The minimum required information, however, only includes a periodic income (e.g., monthly gross income 704), that can be expected by the borrower, the total number of rentable units 706 in the property, and the gross building area 708. For the regular submission process, additional information may be entered such as the unit mix 710 (e.g., the type of unit, the number of such units in the property, the range of actual rents that may be expected, and the area of each type of unit). The software adds up the market rents that have been entered and calculates and displays a running total rent (income) for the property, as well as the running total area.

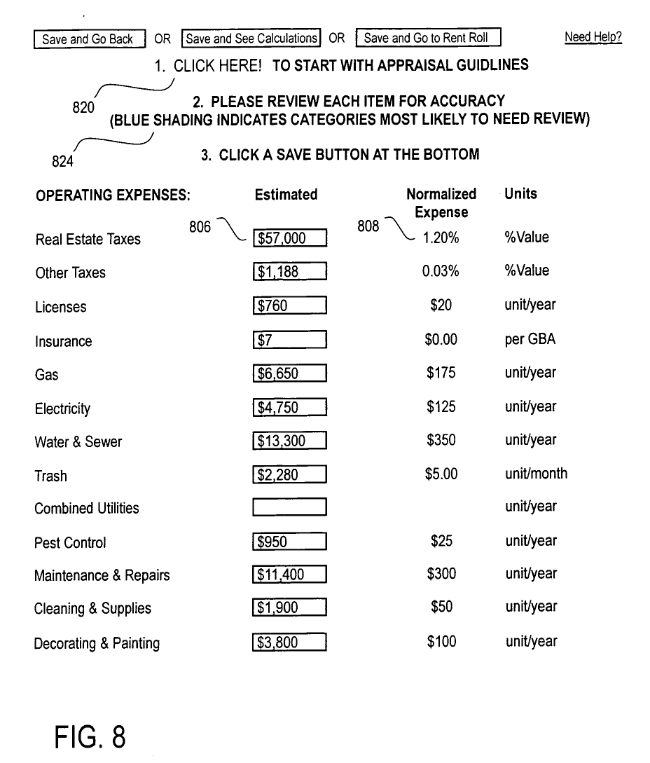

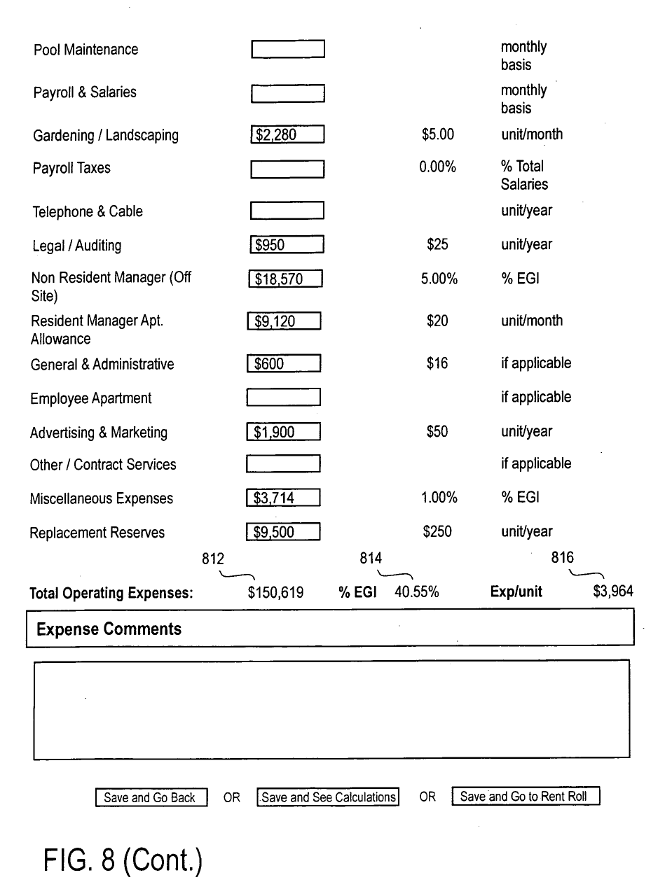

In addition, in the case of an apartment building, for example, additional information may be entered including the number of units that are vacant (item 714), the year the building was built (716) and/or renovated (718), whether or not any units are under rent control ordinances (720), the number of stories (724), the number of buildings (726), whether or not there is a pool (728), as well as the number of parking spaces (730) and whether there is secured parking (732). Additional details concerning whether or not there is an elevator, whether each unit has gas appliances or electric, whether or not there is a shared laundry room, and whether there is a gated entry may also be requested in the form. Further property information may be entered under the comments section, in free form by the user. Having collected the information regarding the income or assets of the property, the software proceeds with the next operation, Property Expenses (FIG. 8).

In FIG. 8, a Web page is displayed that lists a number of estimated, operating expense items 806, preferably using the same nomenclature and sequence found in the appraisal report that has been ordered by the lender. This will advantageously allow for a better integration of broker input and underwriting needs, yielding a faster transition to the final underwriting spreadsheet that will be used by the underwriter, to make a final determination on whether or not to approve the loan for funding. Thus, rather than list the expenses solely in abbreviated form, such as in broader categories that might combine two or more of the items in Form 71A, or omit some of them, the “granularity” of the expenses in FIG. 8 is preferably at the same level of detail as the format used by appraisers when reporting to lenders. If there are any line items in the appraisal report that are not expected to be applicable to the type of property being processed, e.g. a heating fuel charge or snow plow charge is typically not incurred in many regions of California and Arizona, such items may be omitted from the list of items 806, which is still considered to be essentially in the same format as the appraisal report.

In addition to the column of expense items 806 that will be entered by the user, or, as described below can be automatically filled by the software, the displayed Web page also has an additional column, normalized expense items 808. These values are automatically calculated by the software, based on the estimated values in the first column, and based on the previously entered information about the property (e.g., the number of units). While the estimated column is preferably a yearly figure, the normalized expense is given as per unit and/or on a per month basis. At the bottom of the figure, the software calculates the total operating expenses by adding up the values in the estimated column, and computes the expenses as a percentage of the expected gross income. The expenses per unit is also computed, giving the user a quick summary of the expenses associated with the target property and an easy way to compare with other properties.

Although the user can manually fill in the listed expense items 806, the software provides the option of automatically filling in some or all of these items 806. An icon 820 is therefore presented to the user which, if selected, automatically fills in the expense items, either all or just those that have not been yet filled manually by the user. The calculated, estimated expenses are based on a comparison of information that has been filled into the form about the property (see above), to a stored, library of expenses for comparable properties. The values in items 806 are thus estimated, preferably based on appraised expense data for comparable properties. A “comparable property” may be one that has a similar number of units, building area, and in the same zip code, for example. To make the process work more efficiently, the Web page states that the user should review each item for accuracy, and particularly those that have a certain shading that indicates categories that are most likely to need review and that are most likely to result in an accurate loan quote. In this case, these include real estate taxes, other taxes, insurance, gas usage, electricity usage, water and sewer charges, trash collection charges, gardening/landscaping, and resident manager apartment allowance.

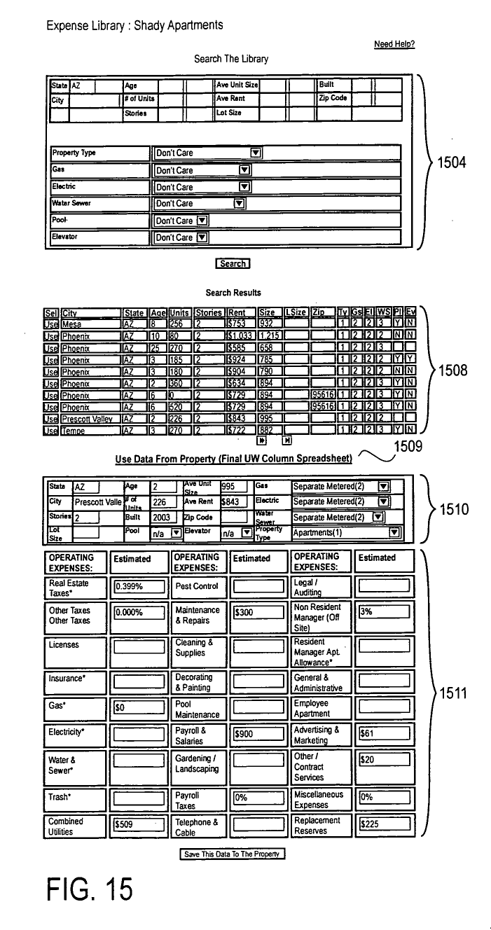

The expense library may include some or all of the operating expenses (e.g., see items 806, FIG. 8), property information (see items 504 in FIG. 5), unit mix (item 710 in FIG. 7) and other characteristics that impact the expenses (see FIG. 7), for previously entered submissions. The expense library may also contain such data for several different property types (if supported by the overall system). The expense library may be entirely maintained by the owner or administrator of the software, and/or it may be modifiable by the user. For example, an additional software tool may be provided to allow the user to directly and manually update his own version of the expense library. In that case, the user may wish to search the library himself to determine the comparable properties, and the expenses associated with them, and, based on the results obtained from the expense library, manually fill in the expense items for the target property. See FIG. 15 which shows an example Web page for the user to access the expense library tool.

In FIG. 15, a search area 1504 receives search criteria from the user. For example, the user may specify that the stored data for all properties in a particular city and state, with a number of units in a certain range, be retrieved. The results of the search are displayed (1508). The property characteristics fields 1510 of the target property are filled automatically by the software (based on the filled sections of the form, discussed above). The operating expenses in area 1511 can then be filled in manually by the user studying the numbers in area 1508, or automatically (according to formulas in the software). Selecting the icon 1509 will also add the property (including the information in fields 1510 and 1511) to the expense library. Only reliable expense numbers should be added to the library.

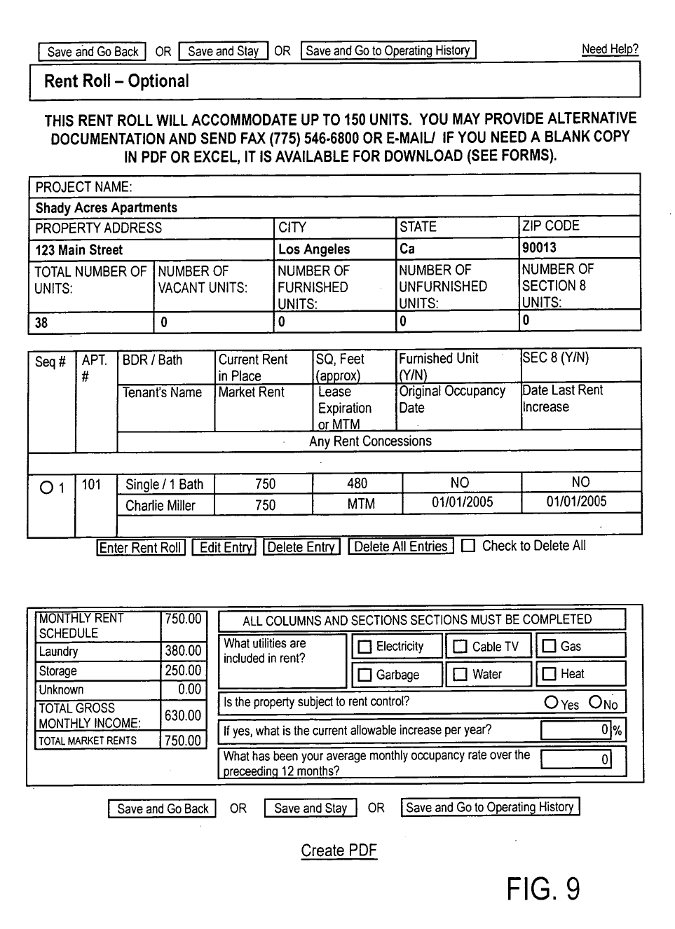

Returning to the Property Expenses section in FIG. 8, at this point, if the user had selected the accelerated option, the user is prompted to submit the form to a loan analyst who will determine which lenders are the most appropriate ones to receive information taken from the filled form, to obtain a loan quote. Because the income and a relatively detailed list of itemized expenses have been filled in the form, it is expected that many U.S. lenders will require no further input from the user regarding the expenses associated with the piece of property, before issuing a loan quote letter. Of course, there may be some lenders that cannot pre-qualify the loan quote at this stage, and therefore will request additional information. This additional information may include additional information about the borrower's credit and experience, a complete rent roll that provides additional data regarding the rental units individually, and an operating history for the property in the past two or three years (items requested in the regular submission process). In many cases, that should also be enough to obtain a conditional approval for the loan, from the lender. According to a further embodiment of the invention, the software allows for such additional information to be easily entered for the target property. Using the online interactive form, the saved target property is simply recalled (see FIG. 13) after the broker has logged in again and the regular submission process is selected. FIGS. 9-12 show the additional sections to be filled out in the regular version of the form.

FIG. 9 shows a Web page for the Rent Roll section. Much of the information requested to be filled in this form is similar to that of a conventional rent roll for a multi-family dwelling transaction. On a commercial version of this section, e.g. office building or strip center, the lease summary and the operating expense portions would be different both in content and format. For example, lease expirations, common area expenses, and what percentage of the expenses is paid by lessee would be important considerations to the lender. In contrast, the operating expenses in a multi-family dwelling are generally not reimbursed.

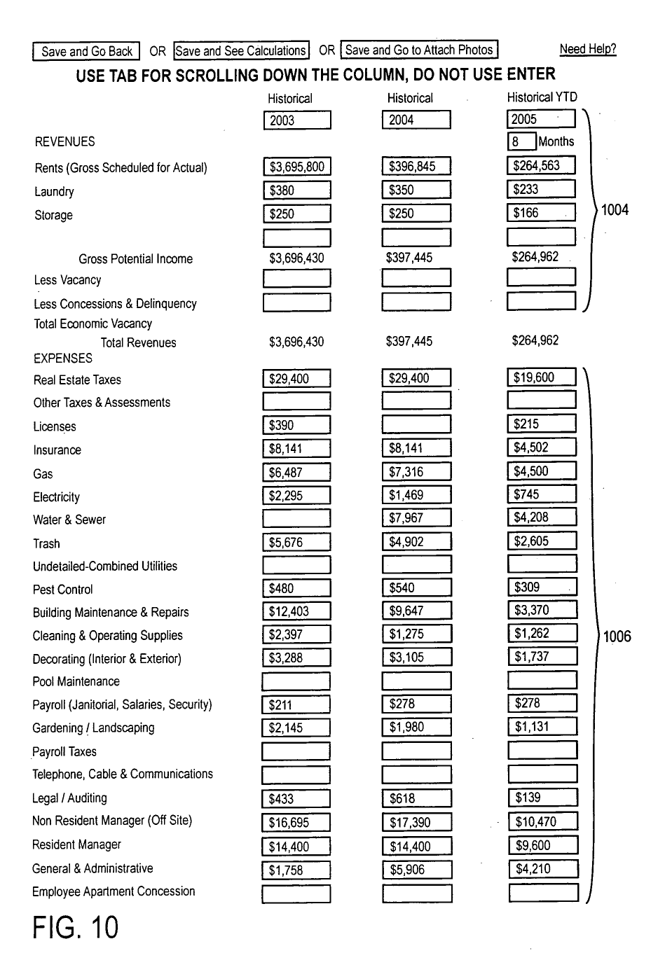

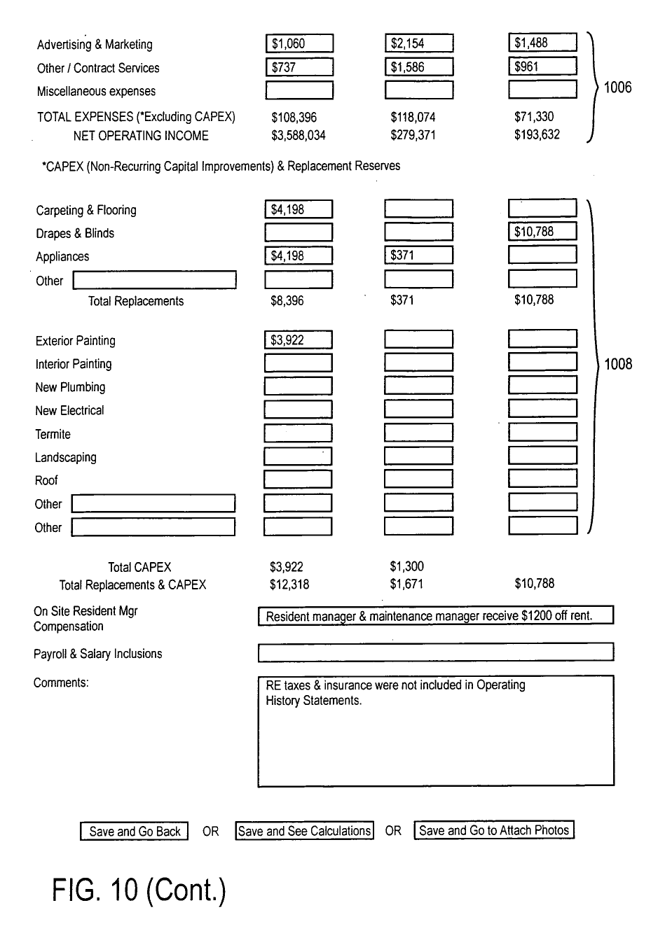

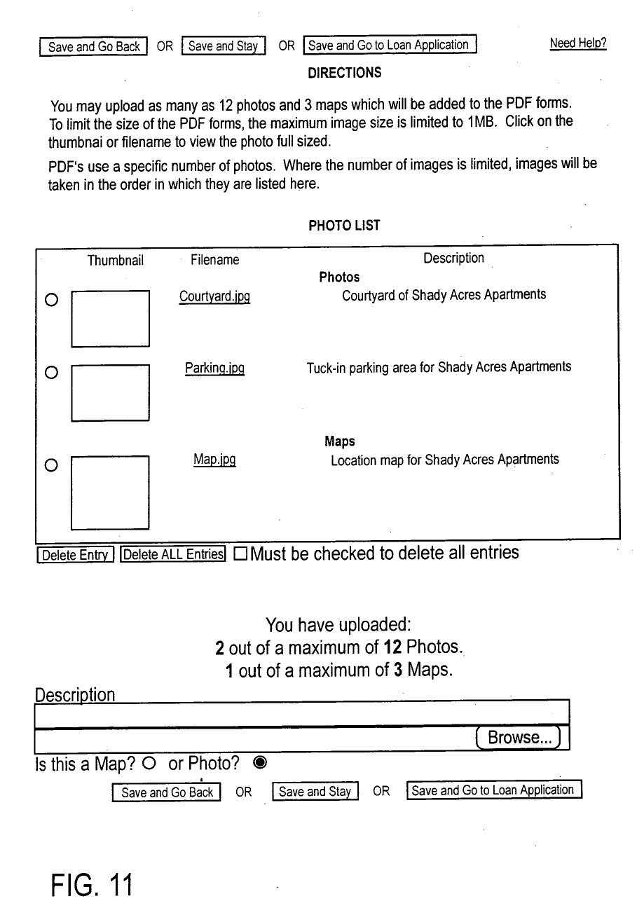

The Operating History section depicted by the example Web page of FIG. 10 contains revenue and expense items (where these are once again preferably arranged in the sequence and at the level of detail of Form 71A) requested for three consecutive years up to the current date. Revenue items 1004 in this case include rents, laundry (from, for example, coin operated laundry machines in a common laundry area), and storage revenue. Note that the data shown outside the dialog boxes or cells is that which is calculated by the software automatically. These include gross potential income and total revenues. The section also includes expense items 1006. A net operating income is automatically calculated for each year, subtracting total expenses from total revenue. The Operating History section also provides for nonrecurring capital improvement items and replacement reserves (1008) which are also provided with separate totals. When the user has finished entering the information in the Operating History section, he may proceed to the next section, Attaching Photos (FIG. 11).

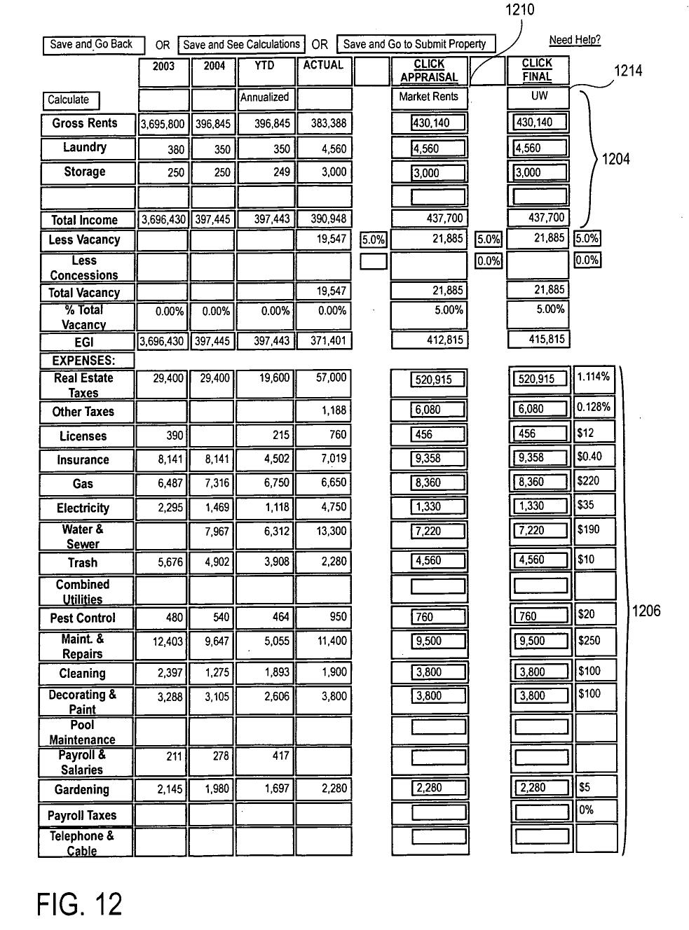

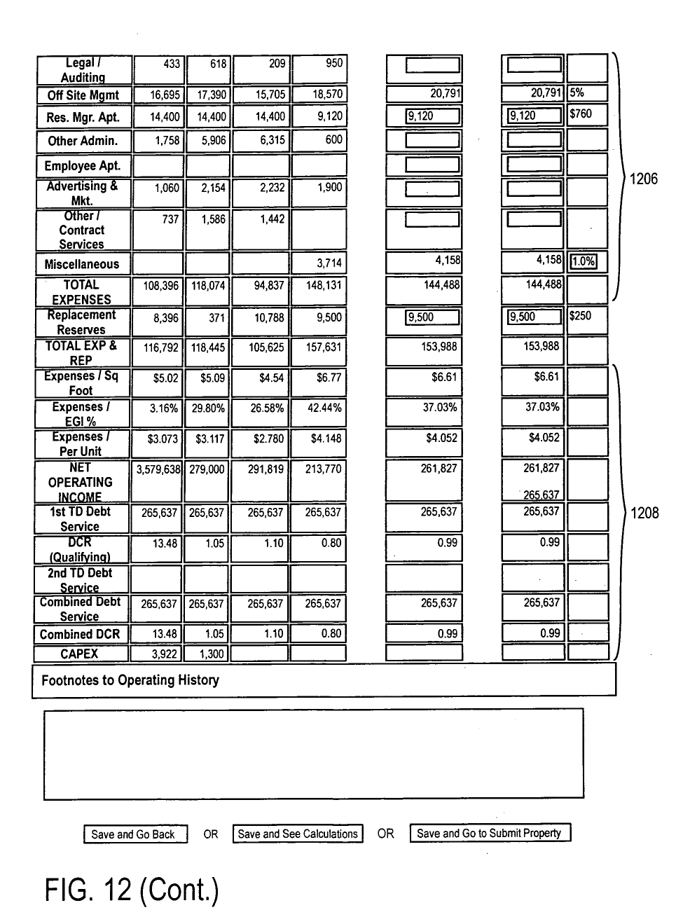

In FIG. 11, an example Web page is shown that allows the user to attach multiple color photographs of the target property, and has a portion for entering a text description of each photograph. In addition, a digital, map image may be attached showing the location of the target property. Once completed with any photographs or maps, the user may then select to proceed to the next section of the form, the Spreadsheet section (FIG. 12).

In FIG. 12, the example Web page shows a spreadsheet that has a number of items, including rents and other sources of income (1204), expenses (1206, still preferably listed at essentially the same level of detail and sequence of Form 71A), and ending with a number of loan and/or investment figures of merit 1208 (including, in this case, first trust deed debt service, debt coverage ratio, combined debt service, and capitalization expense (CAPEX). These items are listed for, in this example, up to three previous years and are populated automatically by the software based on the previously entered information in the form.

The spreadsheet also includes an Appraisal column 1210 which when selected by the user allows the user to manually, or the software to automatically, enter inputs from a received appraisal for the property. This, of course, assumes that a professional appraisal of the target property has now been completed. The categories of particular interest for multi-family properties include gross rents, laundry, storage, vacancy percentage, other concessions, and, for the expenses section, licenses, pest control, maintenance and repairs, cleaning, decorating and paint, pool maintenance, as well as other items. Note that certain items may be highlighted (e.g., shaded in a particular color), indicating that the user should look at those carefully as they will strongly impact the decision of the lender to issue a conditional approval. For this particular example of a multi-family apartment building, the highlighted items are real estate taxes, other taxes, insurance, gas, electricity, water and sewer, trash, gardening, and residential manager apartment allowance. This highlighting of the important items may, of course, change depending on the type of property to be financed. The spreadsheet also includes a Final/Underwriting column 1214. This column 1214 would reflect the adjustments made manually by the user, to determine their effect on the figures of merit 1208.

Following completion of the Spreadsheet section, the detailed form is ready to be submitted by the user to the loan analyst, who will then forward the entire form to the appropriate lenders for consideration in issuing the conditional approval. Once submitted, the target property will appear on the property list associated with this particular broker's account on the software, and will be indicated with the status 1308: submitted (see FIG. 13).

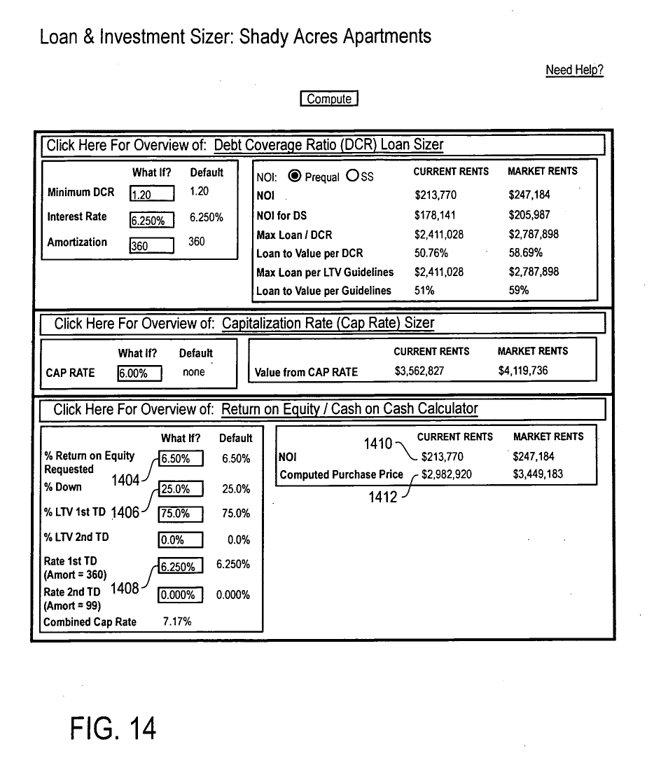

FIG. 13 also shows that the software may be fitted with a number of tools (items 1310) that help the user accelerate decision making concerning the target property. For example, referring now to FIG. 14, an example Web page for a loan and investment sizer tool is shown. This is an interactive online tool for sizing the transaction. The software provides a number of formulas that use the automatically filled items of the form and calculate figures of merit, such as debt coverage ratio, capitalization rate, and return on equity/cash-on-cash, as a function of a number of parameters. This so called “What if?” capability allows the user to manipulate the data for one or more figures of merit (e.g., return on equity field 1404, down payment field 1406, and first trust deed interest rate field 1408), and in response calculate the purchase price (field 1412) that would be needed to meet the specified figure of merit (based on the rents field 1410). This feature could be used by a realtor to evaluate the transaction for the borrower/investor. For example, if the investor wishes a certain return on equity, then the software quickly indicates what the purchase price should be (based on the existing income and expense numbers that have been entered into the form and based on the selected loan program.)

Other tools that may be made available to the user, under the Tools section of the Web page in FIG. 13, include a loan program sizer (to see how the different loan programs compare in terms of interest expenses, for example, as applied to the target property), an expense estimator (to see how changing certain expense categories affects the total operating expenses of the target property and in relation to the EGI, expected gross income), and a financial calculator (to determine the loan payment characteristics for the selected loan program, including number of monthly payments, interest rate, and monthly payment).

Another useful tool for the mortgage professional is the expense library, an example Web page for which is shown in FIG. 15 and that was discussed above.

Back End

The back end of the software, to interface with the lender, may take a number of different forms. As mentioned above, one technique is to make available at the completion of the form by the user, either with the regular or the accelerated submission process, a broker submission package. Advantageously, this package, which may be either in a document format, such as pdf, or a spreadsheet format, such as MICROSOFT EXCEL, has a spreadsheet section (see FIG. 16) in which operating expenses cells 1604 are in such a format that allows the underwriter to process the loan application more efficiently. That is because the sequence and nomenclature of the expense items produced in the broker submission package (which is based on the information entered by the user and/or filled in automatically) is preferably the same as in the appraisal report that will be received by the lender (e.g., Form 71A). Thus, rather than the loan officer at the lender having to translate between the abbreviated expense categories in the conventional loan submission package, to the appraisal guidelines format used by the underwriter for final approval, the submission package from the broker already presents those expenses in the correct format. In addition, realistic estimates of the individual items have already been filled in, preferably automatically by the software, thereby facilitating a decision on the pre-qualification loan quote. In addition, the software inserts a Final Underwriting column 1609 that has the expense cells 1604 formatted according to the lender's internal format. For example, the lender may like to combine several utility line items into one, the Undetailed-Combined Utilities cell 1612. In that case, values for Gas (1614), Electricity (1616), and Trash (1618) taken from the Actual column 1605 would be combined by the software into the single, Combined Utilities cell 1612 in the Final Underwriting column 1609. For comparison, the Actual column 1605 listing the values given by the broker may also be included. Note the spreadsheet already includes an Appraisal column 1607, ready to be used by the lender to insert the appraisal information once received.

When the lender has requested additional information from the broker, before it can issue a conditional approval letter, the internal spreadsheet maintained by the software can simply be updated by the user (via the online interactive form in which the sections not used in the accelerated process, namely the operating history, rent roll, and photographs may be completed). Such updates can be automatically ported to the Actual column 1605 and the Final Underwriting column 1609 of an updated submission package to the lender. These technical advantages are believed to significantly reduce the cost of processing loan submissions, not just for the underwriter (lender) but also for the broker.

A further embodiment of the invention includes the software needed to automatically generate an executive summary (similar to one that is conventionally prepared by an underwriter for a loan committee of a lender), that is available via the online interactive interface of the software back end. An employee of the lender will thus be able to click on an icon that automatically generates the executive summary based on the up to date information in the spreadsheet (e.g., see FIG. 16). Such an expanded back end interface would save the lender substantial time in not only communicating with the broker, via the online interactive interface at the front end, but also taking advantage of the ability of the software to populate the numbers in an executive summary relatively quickly, based on the available spreadsheet.

An embodiment of the invention may be a machine readable medium having stored thereon instructions which program a machine to perform some of the operations described above, e.g. operating the front end and back end of a loan origination and underwriting process. A machine-readable medium may include any mechanism for storing or transmitting information in a form readable by a machine (e.g., a processor, a computer; a network of computers), not limited to Compact Disc Read-Only Memory (CD-ROMs), Read-Only Memory (ROMs), Random Access Memory (RAM), Erasable Programmable Read-Only Memory (EPROM), and a transmission over the Internet.

The invention is not limited to the specific embodiments described above. For example, although the front end operations are preferably in the sequence described above, the arrangement of the sections in their respective Web pages, as well as the ordering of some of the sections across Web pages, may be different in a particular application. Accordingly, other embodiments are within the scope of the claims.

What is claimed is:

1. A method for processing information to finance a property that is to be operated as a business, comprising:
making available to a user, an online interactive form that requests information about the property to be financed;
receiving via the online form some of the requested information as filled out by the user, wherein the online form has an expense section that lists a plurality of different expense items associated with owning the property;
automatically filling in some of the items in the expense section that have not been filled by the user; and
transmitting information taken from the filled form, to a plurality of lenders to know their interest in financing the property.

2. The method of claim 1 wherein the information transmitted to the lenders includes the plurality of different expense items in essentially the same format of an appraisal report, and the expense items number at least five.

3. The method of claim 1 wherein the information transmitted to the lenders includes the automatically filled expense items, the method further comprising receiving a loan quote letter from one of the lenders, to finance the piece of property, based on the transmitted information and without requiring further input from the user regarding expenses associated with the piece of property.

4. The method of claim 1 wherein the piece of property is a multifamily dwelling and the expense items include at least five of the following, arranged in the line item sequence of a professional real estate appraiser's appraisal reporting form: real estate taxes, other taxes, licenses, insurance, gas, electricity, water and sewer, trash, pest control, building maintenance and repairs, cleaning and operating supplies, decorating, pool maintenance, janitorial personnel, security personnel, gardening, communications, legal and auditing, building manager fees, advertising and marketing, all of which if included are to be automatically filled, if not filled by the user.

5. The method of claim 1 further comprising:
automatically updating a spreadsheet file based on the received information and the automatically filled items, to calculate one of debt coverage ratio and capitalization rate, wherein the spreadsheet file contains the plurality of expense items which are in essentially the same format as they appear in an appraisal report from a professional appraiser,
and wherein the information transmitted to one of the lenders includes the spreadsheet file.

6. The method of claim 1 wherein the information transmitted to one of the lenders
a) includes the automatically filled expense items which are in essentially the same format as they appear in an appraisal report received by said one of the lenders, and
b) is in the form of one of a document file and a spreadsheet wherein the spreadsheet includes formulas for loan figures of merit that are linked to and are updated based on income and expense cells in the spreadsheet.

7. An article of manufacture, comprising:
a machine-readable medium having stored therein data that when accessed by a machine
provides a user an online interactive interface to fill in a loan origination form to finance property, wherein the form requests information about the property,
compares some of the information that has been filled into the form by the user to a stored library of expenses for comparable properties and, based on the comparison, fills in a plurality of expense items in the form; and
prepares a plurality of mortgage broker submission packages identifying the property, each package includes the information that has been filled into the form and a plurality of filled, expense categories that are derived from the filled expense items and that have been customized for a respective one of a plurality of lenders, wherein a customized, filled expense category combines two or more of the filled expense items.

8. The article of manufacture of claim 7 wherein the data when accessed by the machine
enters the information that has been filled into the form, including the filled expense items, into a spreadsheet, and
updates the spreadsheet with additional information requested from the user to approve a loan, and
provides an online interactive interface to information reflected in the spreadsheet that informs decisions to issue a pre-qualification loan quote, a conditional loan approval, and final underwriting for financing the property.

9. The article of manufacture of claim 7 wherein the data when accessed by the machine causes the form to include a rent roll for the property, allows the user to update the filled expense items in the form and add historical data about past expenses, and allows the user to attach a photograph of the property.

10. The article of manufacture of claim 7 wherein the data when accessed by the machine causes the form to offer an accelerated process to obtain a pre-qualification loan quote that requires no more than the following information from the user: a) the property address, b) one of purchase and refinance, c) one of purchase price and loan amount, d) income to be generated by the property, e) number of rentable units in the property, and f) building area.

11. The article of manufacture of claim 7 wherein the data when accessed by the machine causes the information filled into the form by the user to be discarded unless the user has elected to submit the form to obtain an initial decision on a loan program to finance the property.

12. The article of manufacture of claim 7 wherein the data when accessed by the machine
provides an interactive online tool that uses information previously entered in the form by the user, to calculate an investment figure of merit for purchase of the property, and
allows the user to change an investment figure of merit and in response calculates the purchase price that will be needed to meet the changed figure of merit.

13. The article manufacture of claim 7 wherein the data when accessed by the machine automatically prepares an electronic, broker submission package to be submitted to a lender to gauge interest in financing the property, the broker submission package includes information on the property entered by the user and items requested in the form as filled in automatically by the machine.

14. The article of claim 7 wherein the data when accessed by the machine automatically prepares an electronic, realtor marketing package to be submitted to an investor to gauge interest in purchasing the property through financing, wherein the realtor package includes information on the property entered by the user and items requested in the form as filled in automatically by the machine.

15. A system for loan origination and underwriting, comprising:
machine means for providing a user an online interactive interface to fill in a loan origination form to finance a business, wherein the form requests information about the business including a plurality of expense items associated with operating the business; and
machine means for transmitting information that is reflected in the filled form to a lender and that informs the lender's decision to approve a loan for financing the property, wherein the transmitted information reflects the plurality of expense items in essentially the same format as a form used by a professional appraiser to report to the lender an appraisal of the business.

16. The system of claim 15 wherein the expense items in the loan origination form are in essentially the same format as the form used by the appraiser to report to the lender.

17. The system of claim 15 further comprising:
machine means for providing an option to the user of a) the system comparing the information that has been filled into the form by the user to a stored library of expenses for comparable businesses and automatically filling in some or all items of expenses requested in the form, and b) allowing the user to manually fill in some or all of the items.

18. A system for loan origination and underwriting, comprising:
machine means for providing a user an online interactive interface to fill in a loan origination form to finance a business where the form requests information about the business including a first plurality of expense items associated with operating the business; and
machine means for transmitting information that is reflected in the filled form to a lender wherein the transmitted information reflects a second plurality of expense items that are essentially in the format of a spreadsheet used by the lender to calculate a loan figure of merit that informs the lender's decision to approve a loan to finance the business.

19. The system of claim 18 wherein the first plurality of expense items in the loan origination form are in essentially the same format as a form used by a professional appraiser to report to the lender an appraisal of the business.
